(19) United States
(12) Patent Application Publication
(10) Pub. No.: US 2004/0076841 A1
(43) Pub. Date: Apr. 22, 2004

(54) Multi-layered composite material with organic sandwich layers based on rubber

(76) Inventors: Rauf Sauer, St. Leon-Rot (DE); Peter Born, Sandhausen (DE); Angelika Butt, Griesheim (DE)

Correspondence Address: Connolly Bove Lodge & Hutz, P O Box 2207, Wilmington, DE, 19899-2207, US

(21) Appl. No.: 10/450,735

(22) PCT Filed: Dec. 7, 2001
(86) PCT No.: PCT/EP01/14385

(30) Foreign Application Priority Data
Dec. 16, 2000 (DE) 100 62 859.1

(51) Int. Cl. B32B 15/08

(52) U.S. Cl. 428/462

(57) ABSTRACT

Binder compositions based on vulcanizable rubber materials containing liquid polyenes, optionally solid rubbers and/or thermoplastic polymer powders as well as vulcanizing agents are suitable for the production of multilayer laminates consisting of two outer metal sheets and an intermediate binder layer. This intermediate layer may optionally contain in addition incorporated sheet material of synthetic fibers and/or metallic expanded meshes, wire meshes and the like.

Such multilayer laminates are suitable for the fabrication of specifically light materials in mechanical engineering, vehicle or instrument construction, in particular for automobile construction.

The present invention relates to a multilayer laminate of two outer metal sheets and an intermediate layer containing an organic binder matrix, as well as a process for the production of these multilayer laminates.

Multilayer laminates and processes for the production of multilayer laminates are employed everywhere where it is important to use specifically light structures having high strength and/or rigidity values.

Specifically light materials are increasingly used in mechanical engineering, vehicle manufacture or instrument manufacture, in particular in automobile manufacture, in order to reduce the weight of for example the vehicles. Aluminum, fiber composite materials or also high-strength car body steels are for example used. The use of ever stronger materials with ever-thinner sheet thicknesses can of course in very many cases satisfy the strength requirements, but not however the rigidity requirements of the structural parts. Lightweight construction with ever thinner sheet thicknesses is ultimately limited by the fact that, due to geometrical factors, the reduced cross-sections of the structural parts no longer satisfy the rigidity requirements as regards fitness for use. Examples of known multilayer composites are web plates, and hump-shaped and trapezoidal composite sheets in their multifarious embodiments. The reshaping of produced geometrical shapes with an internal supporting intermediate layer forms the basis of the technical solutions for this type of lightweight construction. Suitable as intermediate layers in this connection are, inter alia, foamed core fillings with polymeric foams or also with metallic foams or inorganic silicate-based foams.

Preferred technical applications nowadays in particular employ a three-layer material composite consisting of two top sheets and an intermediate layer of a viscoelastic material. On account of the relatively thin intermediate layer, which as a rule hardly contributes to increasing the rigidity, these types of composite sheets are used mainly on account of their vibration-damping properties.

A composite material for thermal insulation and/or sound insulation is known from DE-A-3905871, which has at least on one side a structurally rigid covering layer of a thermally stable metal film. A thermally resistant, highly porous, inorganic material, for example foamed glass having a sponge-like structure, or porous concrete or foamed ceramic or clay mineral materials, is proposed as insulation layer. Exhaust sections of automobiles have been suggested as a suitable application for this composite material in the automobile sector.

A process for producing multilayer composite plates is known from DE-A-3935120, in which these composite plates consist of a top plate and a bottom plate and a web material of wire or a metal mesh interposed therebetween as web material, which before being joined to the outer metal plates is deformed by flattening its mesh nodal points. In this way enlarged joining areas are created between the metal mesh and the metal plates, which should also facilitate reshaping. This publication discloses more specifically that the joining of the metal mesh to the cover plates may in principle be carried out by adhesion processes, though it should preferably be performed by welding processes. This publication does not give any further details of suitable adhesives.

WO 00/13890 describes bonded multilayer composite plates and processes for the production of multilayer composite plates consisting of two outer metal plates that serve as upper and lower base plates and that are joined to a deformable bonding intermediate layer. The deformable web material situated in the intermediate layer is joined to the top and bottom plates by means of a foaming adhesive that fills the cavities remaining in the composite material. The web material lying between the metal plates may consist of an expanded metal mesh, a wire mesh or a web plate and may include a multilayer sequence of expanded metal meshes, wire meshes and web plates with intermediate plates that are impermeable or permeable to the adhesive. This publication does not give any details of suitable compositions of the adhesive.

Having regard to the prior art the inventors have set themselves the task of providing binders that are suitable for the production of multilayer laminates, in particular laminates that are constructed from outer metal sheets and an intermediate layer.

The achievement of this object according to the invention is disclosed in the claims, and substantially consists in providing multilayer laminates that may be produced from two outer metal sheets and an intermediate layer of a binder matrix and optionally a sheet material incorporated therein, the binder composition being a vulcanizable rubber material based on at least one liquid elastomer having reactive groups.

In a particularly-preferred embodiment the composition of the binder is such that it permits the production of weight-optimized, light laminates with acoustic and/or reinforcing properties. To this end the binder system may for example contain “chemical” blowing agents or expandable hollow microspheres or expanded hollow microspheres.

The invention also provides a process for the production of the aforementioned multilayer laminate, which comprises the following essential process steps:

a) application of the vulcanizable rubber composition to be used according to the invention to a metal sheet with the aid of a broad-slit nozzle or a roller applicator,

b) optionally applying the sheet material to the rubber composition,

c) superimposing the second metal sheet,

d) optionally compressing the composite to the predetermined thickness,

e) hardening of the rubber-adhesive layer by heating the composite to temperatures between 80° C. and 250° C., preferably between 160° C. and 200° C.

The last-mentioned step 0 may optionally also be carried out in several stages. To this end the binder composition may be hardened beforehand in a first hardening stage. The multilayer laminate may then be subjected to reshaping processes and punching processes known per se, so that for example preformed car body structural parts can be produced from the laminate that are then assembled in a later working stage using conventional joining processes such as adhesion and/or welding, riveting, screwing or flanging. The final hardening of the binder layer then takes place in a later process step, for example in a lacker furnace after electro-dipcoating of the untreated bodywork of a vehicle.

In another embodiment of the process according to the invention the application of the vulcanizable rubber composition does not take place directly on a metal sheet but in a type of “transfer process” on an intermediate carrier. This intermediate carrier may be a covering film treated so as to be anti-adhesive, though it may also be the (reinforcing) sheet material of the intermediate layer for the multilayer laminate. In the last-mentioned embodiment the binder layer for the intermediate support may be provided with a covering film that may optionally be removed before the application of the binder-coated sheet material to the metal sheets.

The binder matrix used according to the invention consists substantially of hot-hardening, reactive compositions based on natural and/or synthetic rubbers (i.e. elastomers containing olefinic double bonds) and vulcanizing agents that contain at least one of the following substances:

one or more liquid rubbers and/or solid rubbers or elastomers,

finely particulate powders of thermoplastic polymers,

vulcanizing agents, vulcanizing accelerators, catalysts,

fillers,

tackifiers and/or bonding agents,

blowing agents,

extender oils,

anti-aging agents,

rheological auxiliary substances.

Suitable single-component binders are described for example in WO 96/23040, and suitable two-component binders are disclosed for example in EP-A-356715. The teaching of these publications having regard to the rubber compositions is expressly part of the present invention.

The liquid rubbers or elastomers may in this connection be selected from the following group of homopolymers and/or copolymers: polybutadienes, in particular the 1,4- and 1,2-polybutadienes, polybutenes, polyisobutylenes, 1,4- and 3,4-polyisoprenes, styrene-butadiene copolymers, butadiene-acrylonitrile copolymers, wherein these polymers may contain terminal and/or (statistically distributed) side-position functional groups. Examples of such functional groups are hydroxy, amino, carboxyl, carboxylic acid anhydride or epoxy groups. The molecular weight of these liquid rubbers is typically below 20000, preferably between 900 and 10000. The proportion of liquid rubber in the overall composition depends on the desired rheology of the unhardened composition and the desired mechanical properties of the hardened composition. The proportion of liquid rubber or elastomer normally varies between 5 and 50 wt. % of the overall formulation. In this connection it has proved convenient to use preferably mixtures of liquid rubbers of different molecular weights and different configuration with regard to the remaining double bonds. In order to achieve optimal bonding to a wide variety of substrates, in the particularly preferred formulations a proportion of liquid rubber component having hydroxyl groups and/or acid anhydride groups is used. At least one of the liquid rubbers should contain a high proportion of cis-1,4 double bonds, while a further rubber should contain a high proportion of a vinyl double bonds.

Suitable solid rubbers have, in comparison to the liquid rubbers, a significantly high molecular weight (mol.wt.=100000 or more). Examples of suitable rubbers are polybutadiene, preferably with a very high proportion of cis-1,4 double bonds (typically more than 95%), styrene-butadiene rubber, butadiene-acrylonitrile rubber, synthetic or natural isoprene rubber, butyl rubber or polyurethane rubber.

An addition of finely divided thermoplastic polymer powders significantly improves the tensile shear strength while retaining a very high elongation at break, which was previously unusual for structural adhesives. Thus, tensile shear strengths of more than 15 MPa can be achieved, the elongation at break being significantly more than 15%, very frequently more than 20%. The high-strength structural adhesives based on epoxide resins themselves have, being flexibilized adhesive formulations, elongations at break of only less than 5%. A large number of thermoplastic polymer powders are suitable as polymer powders, and by way of example there may be mentioned vinyl acetate, either as a homopolymer or as a copolymer with ethylene as well as with other olefins and acrylic acid derivatives, polyvinyl chloride, vinyl chloride/vinyl acetate copolymers, styrene copolymers, as are described for example in DE-A-4034725, poly(methyl methacrylate) as well as its copolymers with other (meth)acrylic acid esters and functional comonomers, such as are described for example in DE-C-2454235, or polyvinyl acetals such as for example polyvinyl butyral. Although the particle size and particle size distribution of the polymer powders does not appear to be particularly critical, nevertheless the mean particle size should be below 1 mm, preferably below 350 μm, and most particularly preferably between 100 and 20 μm. Polyvinyl acetate and copolymers based on ethylene vinyl acetate (EVA) are most particularly preferred. The amount of thermoplastic polymer powder that is added is governed by the desired strength range and is between 2 and 20 wt. % referred to the overall composition, a particularly preferred range being 10 to 15%.

Since the crosslinking and hardening reaction of the rubber composition has a decisive influence on the tensile shear strength and on the elongation at break of the hardened rubber composition, the vulcanization system must be selected and matched particularly carefully. A large number of vulcanization systems based on elementary sulfur as well as vulcanization systems not containing elementary sulfur are suitable, the latter including the vulcanization systems based on thiuram disulfides. Vulcanization systems without sulfur compounds may also be used. The latter include vulcanization systems based on organic peroxides, polyfunctional amines, quinones, p-benzoquinone dioxime, p-nitrosobenzene and dinitrosobenzene, as well as vulcanization systems crosslinked with (blocked) diisocyanates. Particularly preferred are vulcanization systems based on elementary sulfur and organic vulcanization accelerators as well as zinc compounds. The pulverulent sulfur is in this connection used in amounts of 1 to 15 wt. % referred to the overall composition, amounts of between 4 and 8% being particularly preferred. Organic accelerators that are suitable include the dithiocarbamates (in the form of their ammonium or metal salts), xanthogenates, thiuram compounds (monosulfides and disulfides), thiazole compounds, aldehyde-amine accelerators (e.g. hexamethylenetetramine) as well as guanidine accelerators, most particularly preferred being dibenzothiazyl disulfide (MBTS). These organic accelerators are used in amounts of between 2 and 8 wt. % referred to the overall formulation, preferably in amounts of between 3 and 6%. Zinc compounds acting as accelerators may be selected from zinc salts of fatty acids, zinc dithiocarbamates, basic zinc carbonates as well as, in particular, finely particulate zinc oxide. The content of zinc compounds is in the range between 1 and 10 wt. %, preferably between 3 and 7 wt. %. In addition further typical rubber vulcanization auxiliary substances such as for example fatty acids (e.g. stearic acid) may be included in the formulation.

Although the compositions to be used according to the invention as a rule already have a very good adhesion to the substrates to be bonded due to their content of liquid rubber containing functional groups, if necessary tackifiers and/or bonding agents may be added. Suitable for this purpose are for example hydrocarbon resins, phenol resins, terpene-phenol resins, resorcinol resins or their derivatives, modified or unmodified resin acids and esters (abietic acid derivatives), polyamines, polyaminoamides, anhydrides and anhydride-containing copolymers. Also, the addition of polyepoxide resins in minor amounts (<1 wt. %) can improve the adhesion in the case of many substrates. For this purpose however preferably solid epoxide resins with a molecular weight significantly above 700 are then used in finely comminuted form so that the formulations are substantially free of epoxy resins, in particular those with a molecular weight below 700. If tackifiers and/or bonding agents are used, their nature and amount depends on the polymer composition of the adhesive/sealant, on the desired strength of the hardened composition, and on the substrate to which the composition is applied. Typical tackifying resins (tackifers) such as for example terpene-phenol resins or resin acid derivatives are normally used in concentrations of between 5 and 20 wt. %, while typical bonding agents such as polyamines, polyaminoamides or resorcinol derivatives are used in the range between 0.1 and 10 wt. %.

In order to produce foaming during the hardening process, in principle all conventional blowing agents may be used, for example organic blowing agents from the class comprising azo compounds, N-nitroso compounds, sulfonyl hydrazides or sulfonyl semicarbazides. As regards the azo compounds to be used according to the invention there may be mentioned by way of example azobisisobutyronitrile and in particular azodicarbonamide, from the class of nitroso compounds there may be mentioned by way of example di-nitrosopentamethylenetetramine, from the class of sulfohydrazides there may be mentioned 4,4′-oxybis-(benzenesulfonic acid hydrazide), diphenylsulfone-3,3′-disulfohydrazide or benzene-1,3-disulfohydrazide, and from the class of semicarbazides there may be mentioned p-toluenesulfonyl semicarbazide. The aforementioned blowing agents may also be replaced by the so-called expandable hollow microspheres (“expandable microspheres”), i.e. non-expanded thermoplastic polymer powders that are impregnated or filled with low boiling point organic liquids. Such microspheres are described for example in EP-A-559254, EPA-A-586541 or EP-A-594598. Although not preferred, already expanded hollow microspheres may also be used or used in conjunction. These expandable/expanded hollow microspheres may optionally be combined in arbitrary quantitative ratios with the “chemical” blowing agents mentioned above. The chemical blowing agents are used in foamable compositions in amounts of between 0.1 and 3 wt. %, preferably between 0.2 and 2 wt. %, and the hollow microspheres are used in amounts of between 0.1 and 4 wt. %, preferably between 0.2 and 2 wt. %.

The compositions to be used according to the invention are preferably free of plasticizers for the thermoplastic polymer. In particular they are free of phthalic acid esters. It may however be necessary to influence the rheology of the unhardened composition and/or the mechanical properties of the hardened composition by adding so-called extender oils, i.e. aliphatic, aromatic or naphthenic oils. This effect is however preferably achieved by the appropriate choice of the low molecular weight liquid rubbers or by the co-use of low molecular weight polybutenes or polyisobutylenes. If extender oils are employed, they are used in the range between 2 and 15 wt. %.

The fillers may be selected from a large number of materials, and in particular there may be mentioned in this connection chalks, natural comminuted or precipitated calcium carbonates, calcium/magnesium carbonates, silicates, barytes, graphite as well as carbon black. Platelet-like fillers, such as for example vermiculite, mica, talcum or similar layer silicates are also suitable as fillers. It may optionally be convenient if at least a proportion of the fillers have been subjected to a preliminary surface treatment, and in particular it has proved expedient for the various calcium carbonates or chalks to be coated with stearic acid in order to reduce trapped moisture and to reduce the moisture sensitivity of the hardened composition. In addition the compositions according to the invention as a rule contain between 1 and 20 wt. %, preferably between 5 and 15 wt. % of calcium oxide. The total proportion of fillers in the formulation may vary between 10 and 70 wt. %, and the preferred range is between 25 and 60 wt. %.

Conventional stabilizers, such as for example sterically hindered phenols or amine derivatives, may be used to counteract thermal, thermooxidative or ozone destruction of the compositions according to the invention, typical amounts of these stabilizers being 0.1 to 5 wt. %.

Although the rheology of the compositions according to the invention may normally be adjusted to the desired range by the choice of fillers and amount of low molecular weight liquid rubbers, conventional rheology auxiliary substances such as for example pyrogenic silicic acids, bentones or filamentary or pulp short fibers may be added in an amount of between 0.1 and 7%. Further conventional auxiliary substances and additives may moreover be used in the compositions according to the invention.

A sheet material is as a rule bonded in the organic binder matrix of the intermediate layer of the laminate. In principle a large number of materials may be used for this sheet material, and by way of example there may be mentioned nonwovens, fleece materials, fabrics, knitted fabrics based on a wide range of plastics fibers such as for example polyester fibers, polypropylene fibers, polyamide fibers, carbon fibers, or also glass fibers. In a particularly preferred embodiment these sheet materials may consist of an expanded metal mesh, a wire mesh, a web plate or a perforated plate. Such metallic sheet materials are known for example from WO 00/13890 or from DE-A-3935120. The sheet materials mentioned therein for use as intermediate layers of multilayer laminates are expressly covered by this application.

The two outer metal sheets have a thickness of between 0.1 and 0.5 mm, preferably between 0.2 and 0.3 mm. In this connection these sheets may be conventional steel sheets, but may also include steel sheets treated by various galvanizing processes, in which connection there may be mentioned electrolytically galvanized, hot-dip galvanized sheets as well as the corresponding thermally post-treated or galvanized or subsequently phosphated steel sheets as well as aluminum sheets or also magnesium sheets.

The laminate accordingly has an overall layer thickness of between 1 mm and 2 mm, preferably between 1.2 and 1.8 mm.

As mentioned in the introduction, the 1-component or 2-component heat-hardening adhesive/sealant compositions mentioned above are employed in the production of multilayer laminates that are preferably used in shell construction in the automobile industry. The hardening of the compositions should take place in the temperature range between 80 and 240° C. within roughly 10 to 35 minutes, optionally in two stages. Temperatures of between 160 and 200° C. are preferably used in shell construction processes. A decisive advantage of the compositions used according to the invention is that here too they exhibit all the advantages of the rubber-based adhesives/sealants known per se, i.e. they have a good aging-resistant adhesion to various types of galvanized steels such as for example electrolytically galvanized, hot-dip galvanized as well as the corresponding thermally post-treated or galvanized and subsequently phosphated steel sheets, as well as ungalvanized steels and aluminum, even when the substrates are also provided with various corrosion-prevention and/or deep drawing oils.

The compositions used according to the invention have the following preferred compositions:

| Wt. % | Chemical Name/Description |
|---|---|
| 3.0-10.0 | cis-1,4-polybutadiene, solid |
| 3.0-8.0 | zinc oxide |
| 2.0-20 | calcium oxide |
| 0.1-2.0 | 2,2-methylene-bis-(4-methyl-6-tert.- |
| | butylphenol) |
| 0.5-5.0 | carbon black |
| 0-2.0 | hollow microspheres |
| 5.0-40.0 | calcium carbonate |
| 5.0-40.0 | calcium carbonate, coated with stearate |
| 5.0-20.0 | liquid polybutadiene, mol. wt. ca. 1800, |
| | cis-1,4 ca. 72% |
| 5.0-30.0 | polybutadiene with active carboxyl groups, |
| | mol. wt. ca. 1700 |
| 2.0-40.0 | low molecular weight, stereospecific |
| | polybutadiene oil, mol. wt. 1800, vinyl 50% |
| 1.0-10.0 | sulfur |
| 0.2-5.0 | MBTS |
| 2.0-10.0 | EVA copolymer, Tg ca. 40° C. |
| 0-5.0 | magnesium oxide |

The invention will be described in more detail in the following examples of implementation, in which the choice of examples is not intended to represent any restriction of the scope of the invention but rather to illustrate specific examples of implementation in model form. Unless otherwise stated all quantitative figures given in the examples are parts by weight.

### EXAMPLES

The compositions of 3 rubber adhesives that were used for the production of multilayer laminates are listed in the following examples 1 to 3.

### Example 1

Structural Adhesive Based on Rubber

| | |
|---|---|
| 3.75 | cis-1,4-polybutadiene, solid |
| 4.00 | zinc oxide |
| 4.95 | calcium oxide |
| 0.50 | 2,2-methylene-bis-(4-methyl-6-tert.-butylphenol) |
| 0.50 | carbon black |
| 0.20 | hollow microspheres |
| 24.60 | calcium carbonate |
| 14.30 | calcium carbonate, coated with stearate |
| 13.50 | liquid polybutadiene, mol. wt. ca. 1800, cis-1,4 |
| | ca. 72% |
| 10.00 | polybutadiene with active hydroxyl groups, mol. |
| | wt. 2800 |
| 5.00 | low molecular weight, stereospecific |
| | polybutadiene oil, mol. wt. 1800, vinyl 50% |
| 7.25 | sulfur |
| 0.95 | MBTS |
| 10.00 | polyvinyl acetate, EVA copolymer, Tg ca. 40° C. |
| 0.50 | imidazole |

### Example 2

Underfeed adhesive based on rubber

| | |
|---|---|
| 9.00 | cis-1,4-polybutadiene, solid |
| 4.00 | zinc oxide |
| 4.95 | calcium oxide |
| 0.50 | 2,2-methylene-bis-(4-methyl-6-tert.-butylphenol) |
| 3.00 | conducting carbon black |
| 21.90 | calcium carbonate |
| 10.05 | calcium carbonate, coated with stearate |
| 23.00 | liquid polybutadiene, mol. wt. ca. 1800, cis-1,4 |
| | ca. 72% |
| 4.00 | polybutadiene with active carboxyl groups, |
| | mol. wt. 1700 |
| 4.80 | sulfur |
| 4.80 | MBTS |
| 4.00 | phenol-novolak-hexamine resin |
| 6.00 | talcum |

### Example 3

2-Component System Based on Rubber According to the Teaching of EP 356715

Component A

| | |
|---|---|
| 4.00 | zinc oxide |
| 4.55 | calcium oxide |
| 0.50 | 2,2-methylene-bis-(4-methyl-6-tert.-butylphenol) |
| 0.50 | carbon black |
| 7.00 | alkylsulfonic acid esters of phenol |
| 0.50 | polyether polyol |
| 38.45 | graphite |
| 14.00 | liquid polybutadiene, mol. wt. ca. 1800, cis-1,4 |
| | ca. 72% |
| 21.00 | polybutadiene with active hydroxyl groups, |
| | mol. wt. 2800 |
| 1.00 | hexamethylene bisthiosulfate |
| 4.00 | sulfur |
| 4.00 | MBTS |
| 1.00 | tetramethylenemethylenediamine |

Component B

| | |
|---|---|
| 6.00 | zinc oxide |
| 4.95 | calcium oxide |
| 0.50 | 2,2-methylene-bis-(4-methyl-6-tert.-butylphenol) |
| 24.00 | graphite |
| 14.00 | liquid polybutadiene, mol. wt. ca. 1800, cis-1,4 |
| | ca. 72% |
| 53.55 | polybutadiene with active carboxyl groups, |
| | mol. wt. 1700 |
| 1.00 | hexamethylene bisthiosulfate |
| 6.00 | sulfur |
| 4.00 | MBTS |

On the one hand aluminum sheets and on the other hand galvanized steel sheets (Elozink) with sheet thicknesses of 0.25 mm were used for the production of the multilayer laminates. To this end a metal sheet was in each case coated with the aforementioned adhesive, then an expanded metal of thickness 0.25 mm according to the teaching of WO 00/13890 was applied as sheet material, following which a second sheet was joined thereto and the whole composite was pressed so that the intermediate layer between the outer sheets had a layer thickness of about 0.25 mm. The composite was then hardened for 30 minutes at 180° C. The measurement results listed hereinbelow were then obtained.

Measurement Results:

| | | | | Aluminum/ |
|---|---|---|---|---|
| | | | | Elozink |
| Test | Ex. 1 | Ex. 2 | Ex. 3 | (Comp.) |
| Tensile Shear | 12.5 MPa | 2.2 MPa | 1.50 MPa | n.a. |
| Strength: | | | | |
| (30 min. 180° C.) | | | | |
| 3-point bending | | | | |
| test/mm | | | | |
| (Aluminum) | | | | |
| 2 mm | 50 | 20 | 23 | 4 |
| 4 mm | 62 | 37 | 44 | 7 |
| 6 mm | 66 | 45 | 56 | 10 |
| 7 mm | 67 | 47 | 60 | 12 |
| 3-point bending | | | | |
| test/mm | | | | |
| (Elozink) | | | | |
| 2 mm | 68 | 42 | 16 | 6 |
| 4 mm | 81 | 52 | 33 | 11 |
| 6 mm | 85 | 58 | 45 | 15 |
| 7 mm | 87 | 60 | 50 | 17 |

Loss factor d as a function of the excitation frequency kHz Structural adhesive according to Example 1

| | 1 kHz | 3 kHz |
|---|---|---|
| Solid steel (reference): | 0.01 | 0.02 |
| Steel/steel with Example 1 | 0.075 | 0.16 |
| Steel/aluminum with Example 1 | 0.12 | 0.20 |

From the standard forces (in N) of the three-point bending test listed above according to DIN 53293 it is clear that the strength and deformation properties when using all three adhesives exhibited excellent values. For purposes of comparison a composite fabricated without using adhesive was employed, in which the three layers consisting of outer sheets/expanded metal were joined to one another by spot welding. From this it is clear that the strength and deformation properties of the multilayer laminates according to the invention are many times better than those obtained without using an adhesive.

At the same time the good acoustic properties of the laminates are clearly documented by the loss factor d compared to normal, single-layer solid steel.

1. A multilayer laminate that can be produced from two outer metal sheets and an intermediate layer of a binder matrix as well as optionally a sheet material incorporated into the binder, characterized in that the binder composition contains a vulcanizable rubber material based on at least one liquid elastomer having reactive groups.

2. A laminate according to claim 1, characterized in that at least one rubber is a liquid polyene from the group comprising 1,2-polybutadiene, 1,4-polybutadiene, polyisoprene, polybutene, polyisobutylene, copolymers of butadiene and/or isoprene with styrene and/or acrilonitrile, copolymers of acrylic acid esters with dienes, the molecular weight of the liquid polyene being in the range from 900 to about 40000.

3. A laminate according to claim 2, characterized in that the liquid polyene(s) additionally contains terminal and/or statistically distributed carboxyl groups, carboxylic acid anhydride groups, hydroxyl groups, amino groups, mercapto groups or epoxy groups as functional groups.

4. A laminate according to at least one of the preceding claims, characterized in that the binder additionally contains at least one solid rubber in an amount of 1.5 to 9 wt. %, preferably 4 to 6 wt. %, referred to the total composition.

5. A laminate according to claim 4, characterized in that it contains one or more solid rubbers from the group comprising cis-1,4-polybutadiene, styrene-butadiene rubber, synthetic isoprene rubber, natural rubber, ethylene-propylene-diene rubber (EPDM), nitrile rubber, butyl rubber and acrylic rubber.

6. A laminate according to at least one of the preceding claims, characterized in that the vulcanization system consists of 1 wt. % to 15 wt. %, preferably 5 wt. % to 10 wt. % of pulverulent sulfur, 2 wt. % to 8 wt. %, preferably 3 wt. % to 6 wt. % of organic accelerators, and 1 wt. % to 8 wt. %, preferably 2 wt. % to 6 wt. % of zinc compounds, preferably zinc oxide, the wt. % referring to the total composition.

7. A laminate according to at least one of the preceding claims, characterized in that the binder additionally contains thermoplastic polymer powders selected from vinyl acetate homopolymers or copolymers, ethylene/vinyl acetate copolymers, vinyl chloride homopolymers or copolymers, styrene homopolymers or copolymers, (meta)acrylate homopolymers or copolymers or polyvinyl butyral, or a mixture of two or more of these polymers, which have a mean grain size of below 1 mm, preferably below 350 μm, most particularly preferably below 100 μm.

8. A laminate according to at least one of the preceding claims, characterized in that the binder system contains blowing agents selected from expandable hollow microspheres or from the group of organic blowing agents comprising azo compounds, in particular azobisisobutyronitrile or azodicarbonamide, nitroso compounds, in particular di-nitrosopentamethylenetetramine, sulfohydrazides, in particular 4,4′-oxybis-(benzenesulfonic acid hydrazide), and semicarbazides, in particular p-toluenesulfonyl semicarbazide.

9. A laminate according to at least one of the preceding claims, characterized in that the binder system additionally contains fillers, expanded hollow microspheres, rheological auxiliary substances, extender oils, bonding agents and/or anti-aging agents.

10. A laminate according to at least one of the preceding claims, characterized in that the two outer metal sheets have a thickness of between 0.1 and 0.5 mm, preferably between 0.2 and 0.3 mm.

11. A laminate according to at least one of the preceding claims, characterized in that the sheet material is an expanded metal mesh, a wire mesh, a web plate or a perforated plate.

12. A laminate according to claim 10, characterized in that the sheet material has a thickness of between 0.7 and 1.2 mm, preferably of about 1 mm.

13. A laminate according to claims 9 to 11, characterized in that the sheet material is joined in an electrically conducting manner to the two outer sheets.

14. A laminate according to claims 9 to 12, characterized in that the total layer thickness of the laminate is between 1 mm and 2 mm, preferably between 1.2 mm and 1.8 mm.

15. A process for the production of a multilayer laminate according to claims 1 to 14, characterized in that the following essential process steps are performed
a) application of a vulcanizable rubber composition according to at least one of claims 1 to 8 to a metal sheet with the aid of a broad-slit nozzle or a roller applicator,
b) applying the sheet material to the rubber composition,
c) superimposing the second metal sheet,
d) optionally compressing the composite to the predetermined thickness,
e) hardening of the rubber-adhesive layer by heating the composite to temperatures between 80° C. and 250° C., preferably between 160° C. and 200° C.

16. A use of multilayer laminates according to claim 15 for the production of lightweight parts for mechanical engineering, vehicle production or instrument production, in particular for automobile construction.
